(19) United States
(12) Patent Application Publication
(10) Pub. No.: US 2004/0045748 A1
(43) Pub. Date: Mar. 11, 2004

(54) Motor vehicle comprising an electric motor drive and an on-board power supply

(76) Inventors: Rolf Bruck, Bergisch Gladbach (DE); Joachim Grosse, Erlangen (DE); Manfred Poppinger, Uttenreuth (DE); Meike Reizig, Bad Munstereifel (DE)

Correspondence Address: LERNER AND GREENBERG, P.A., Post Office Box 2480, Hollywood, FL, 33022-2480, US

(21) Appl. No.: 10/609,886

(22) Filed: Jun. 30, 2003

Related U.S. Application Data
(63) Continuation of application No. PCT/DE01/04889, filed on Dec. 21, 2001.

(30) Foreign Application Priority Data
Dec. 29, 2000 (DE) 100 65 303.0

(51) Int. Cl. B60K 17/28

(52) U.S. Cl. 180/53.8

(57) ABSTRACT

A motor vehicle has an electric motor drive and an on-board power supply. Conventional on-board power supply systems can be operated with fuel cell modules. Here, the motor vehicle further comprises an air conditioning system providing cooling air that has an air conditioning compressor supplied by the electric systems of the vehicle. The electric systems can be either the hybrid drive of the motor vehicle or a separate electric motor driven by a fuel cell module already mounted in the vehicle. High-temperature PEM fuel cells are especially suitable for this purpose.

### CROSS-REFERENCE TO RELATED APPLICATION

This application is a continuation of copending International Application No. PCT/DE01/04889, filed Dec. 21, 2001, which designated the United States and which was not published in English.

### BACKGROUND OF THE INVENTION

1. Field of the Invention

The invention lies in the fuel cell and automotive technology fields. More specifically, the invention is concerned with a motor vehicle comprising an electric motor drive and an onboard power supply for which a fuel cell system is used.

Fuel cell systems for supplying an electric motor with power are to be used in conjunction with motor vehicles. It has also already been proposed, in the case of motor vehicles having an internal combustion engine, to supply the on-board power merely via a fuel cell system. This may be provided as an alternative or in addition to the electric generator that is conventionally present.

Fuel, such as for example hydrogen or a hydrogen-rich combustion gas, on the one hand, and air, on the other hand, have to be supplied in order to operate the fuel cells. Furthermore, coolants are customarily also required.

### SUMMARY OF THE INVENTION

It is accordingly an object of the invention to provide a motor vehicle with an electric motor drive and on-board power supply which overcomes the disadvantages of the heretofore-known devices and methods of this general type and-which provides for further improvements in a motor vehicle of the above type.

With the foregoing and other objects in view there is provided, in accordance with the invention, a motor vehicle, comprising:

an electric motor drive for driving the motor vehicle;

an on-board power supply with at least one fuel cell module; and

an air conditioning system with an air conditioning compressor for cooling air and a connection between the air conditioning compressor and the electric drive for driving the air conditioning compressor.

In accordance with an added feature of the invention, the connection is at least one of an electric transmission and an electric motor connected on a drive side of the air conditioning compressor.

In accordance with an additional feature of the invention, the air conditioning system includes a temperature-controlled regulating device for regulating the air conditioning compressor.

In accordance with another feature of the invention, the connection is an electric transmission connecting the air conditioning compressor to the drive motor of the motor vehicle.

In accordance with a further feature of the invention, there are provided additional electric means for producing the cooling air. Preferably, the electric means are formed by a fuel cell system.

In accordance with a preferred embodiment of the invention, there is provided a latent heat intermediate storage device connected to the air conditioning compressor.

In accordance with again an added feature of the invention, the electric motor drive forms part of a hybrid motor.

In accordance with a concomitant feature of the invention, the fuel cell module contains PEM fuel cells and, preferably, high-temperature PEM fuel cells.

An-air conditioning system with cooling air, the functioning capability and operation of which are always ensured, i.e. irrespective of the operation of the motor vehicle driving motor, is provided by the invention, especially for motor vehicles. In order to produce the cooling air, the air conditioning system comprises an air conditioning compressor which is supplied by an electric drive. The air conditioning compressor is connected to the driving motor of the motor vehicle via an electric transmission.

In the invention, there are electric means for producing the cooling air. A fuel cell system is advantageously, but not exclusively, used for this. The drive of the motor vehicle may, for example, be a hybrid drive, i.e. there is a possibility of selecting between an internal combustion engine and an electric motor.

Other features which are considered as characteristic for the invention are set forth in the appended claims.

Although the invention is illustrated and described herein as embodied in a motor vehicle comprising an electric motor drive and an on-board power supply, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic side view of a motor vehicle with a fuel cell module; and

FIG. 2 is schematic block diagram illustrating a novel design of an air conditioning system for the motor vehicle according to FIG. 1.

### DESCRIPTION OF THE PREFERRED EMBODIMENTS

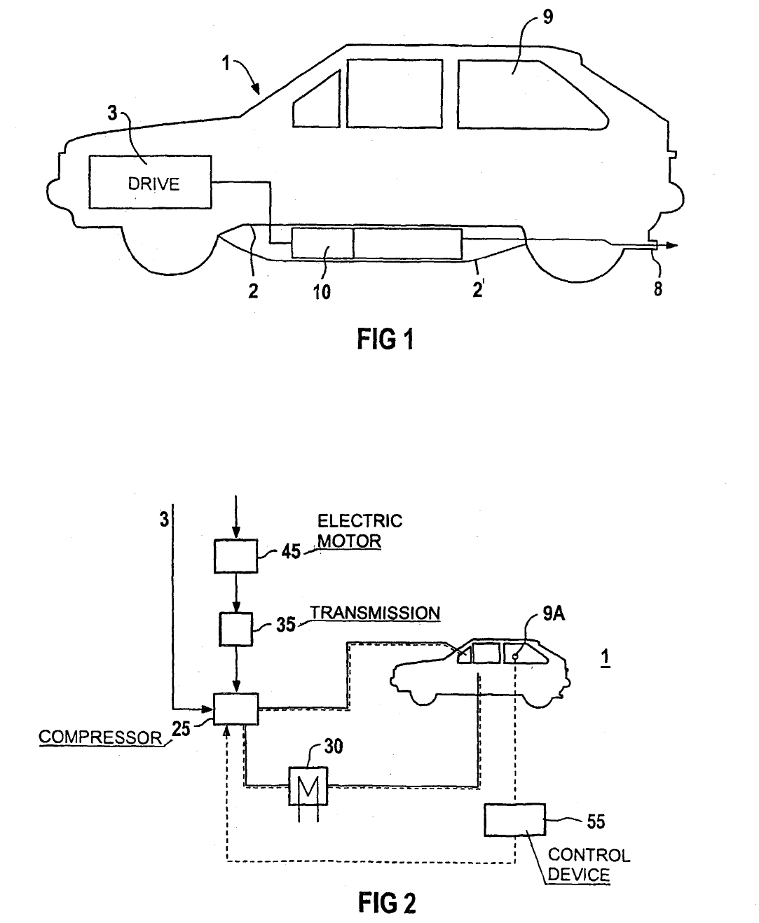

Referring now to the figures of the drawing in detail and first, particularly, to FIG. 1 thereof, there is shown a motor vehicle 1 with a motive drive 3. The drive 3 may be an electric motor, but also may be a hybrid drive comprising an electric motor and internal combustion engine. There is a fuel cell system with at least one fuel cell module 10 specifically for supplying electricity. The fuel cell module 10 is arranged below the floor 2 of the motor vehicle 1 or in a free space formed between the floor 2 and a further floor 2′. Also indicated is an exhaust 8 from which process water, which is produced during operation of the fuel cell module with pure hydrogen and oxygen or air, can escape and, if hydrogen-rich gases with secondary constituents are used, the latter can escape.

Motor vehicles increasingly are provided with air conditioning systems as standard equipment. In such an air conditioning system, the desired temperature in the passenger compartment 9 of the motor vehicle 1 is conventionally predetermined, and an air conditioning compressor system for producing cooling air is activated taking into account the current actual temperature in the passenger compartment 9 and the particular outside temperature.

An air conditioning compressor system of this type will be described further below with reference to FIG. 2.

The previously used air conditioning systems with circulation of coolant and associated electric control units require comparatively large power outputs which can be reliably provided only during operation of the propelling drive of the motor vehicle.

Referring now to FIG. 2, the air conditioning system is characterized essentially by the air conditioning compressor 25 which is connected to the passenger compartment 9 of the motor vehicle 1 by way of fluid lines for conditioned air and is supplied by a drive. There is a temperature-sensor 9A and a temperature-controlled regulating device 55 (open-loop and closed-loop control system) and which supplies control signals for the air conditioning compressor 25.

The electric drive for the air conditioning compressor 25 is customarily the drive 3 of the motor vehicle, that is, if the motor vehicle 1 has an electric motor 45 or a hybrid drive including an electric motor 45. In the instant case, the air conditioning compressor 25 is connected to the hybrid motor via an electric transmission 35, that is the electric motor 45 is connected to the air conditioning compressor 25 via an electric transmission 35. However, it is also possible for the electric motor 45 to be designed as the dedicated drive of the air conditioning compressor 25, but also as a multifunctional motor.

However, other electric means may also be used to produce the cooling air, preferably the fuel cell system with a fuel cell module 10 which is already present for supplying the on-board power. A branch to the fuel cell module 10 of FIG. 1 is shown for this in FIG. 2. The fuel cell module 10 supplies the air conditioning compressor 25 with electric power in a suitable manner.

It is possible to provide an accumulator in addition to or instead of a fuel cell system for supplying the air conditioning compressor 25 with power. If, for example, all of the power of the fuel cell is required for driving the vehicle, which may be the case in high-load or cold-start phases, then the supplying of power is taken over by the accumulator. Furthermore, it is possible to use an electric generator, which may be present, to supply the air conditioning compressor in the same manner that it is possible to use a decentral fuel cell module for supplying the air conditioning compressor.

Within the context of providing air conditioning for the motor vehicle 1, there is also provided a latent heat intermediate storage device 30 in FIG. 2. With a heat storage device 30 of this type, the heat produced in the air conditioning process can be temporarily stored and used for other purposes during the operation of the motor vehicle 1, for example a motor vehicle with a fuel cell drive.

For the system described, PEM (proton exchange membrane, polymer electrolyte membrane) fuel cells are particularly suitable as the electric power source. Fuel cells of this type operate in accordance with the principle of proton conduction in a solid electrolyte at operating temperatures of approximately 60° C., in which case particularly favorable boundary conditions are provided in particular for the high-temperature use of such fuel cells, i.e. uses above 80° C. High-temperature PEM fuel cells (HT-PEM) of this type with operating temperatures of between 80° C. and 300° C., in particular between 120° C. and 200° C. or in a range from 120° C. to 180° C., are distinguished by favorable efficiency.

We claim:

1. A motor vehicle, comprising:
an electric motor drive for driving the motor vehicle;
an on-board power supply with at least one fuel cell module; and
an air conditioning system with an air conditioning compressor for cooling air and a connection between said air conditioning compressor and said electric drive for driving said air conditioning compressor.

2. The motor vehicle according to claim 1, wherein said connection is at least one of an electric transmission and an electric motor connected on drive side of said air conditioning compressor.

3. The motor vehicle according to claim 1, wherein said air conditioning system includes a temperature-controlled regulating device for regulating said air conditioning compressor.

4. The motor vehicle according to claim 1, wherein said connection is an electric transmission connecting said air conditioning compressor to said drive motor of the motor vehicle.

5. The motor vehicle according to claim 1, which further comprises additional electric means for producing the cooling air.

6. The motor vehicle according to claim 5, wherein said electric means are formed by a fuel cell system.

7. The motor vehicle according to claim 1, which comprises a latent heat intermediate storage device connected to said air conditioning compressor.

8. The motor vehicle according to claim 1, wherein said electric motor drive forms part of a hybrid motor.

9. The motor vehicle according to claim 1, wherein said fuel cell module contains PEM fuel cells.

10. The motor vehicle according to claim 1, wherein said fuel cell module contains high-temperature PEM fuel cells.
